(19) United States
(12) Patent Application Publication
(10) Pub. No.: US 2015/0220811 A1
(43) Pub. Date: Aug. 6, 2015

(54) ASSISTED PRODUCT IDENTIFICATION

(71) Applicant: Broan-NuTone LLC, Hartford, WI (US)

(72) Inventors: David George, Hartford, WI (US); Bernadette Long, Hartford, WI (US); Patrick Nielsen, Hartford, WI (US); Richard J. Palmersheim, Mequon, WI (US)

(21) Appl. No.: 14/611,919

(22) Filed: Feb. 2, 2015

Related U.S. Application Data
(60) Provisional application No. 61/935,117, filed on Feb. 3, 2014.

(51) Int. Cl. G06K 9/62; G06Q 30/06; G06T 11/00; G06T 7/00; G06K 9/32

(52) U.S. Cl. CPC G06K 9/6215; G06T 7/0026; G06K 9/3241; G06T 11/001; G06Q 30/0623; G06K 2207/1012; G06T 2207/10024; G06T 2210/12; G06T 2210/62

(57) ABSTRACT

A system and related methods for assisting in the identification of an unidentified object by comparing a visual representation of an unidentified object with a visual mask corresponding to a known product. The mask can include at least one distinctive feature that can be compared to the visual features of the visual representation. Identified correspondence between the mask and the visual presentation can then be used to identify the unidentified object. The visual representation of the unidentified object can be compared against a library of masks to identify the unidentified object, where each mask corresponds to a different known product.

### CLAIM OF PRIORITY

This patent application claims the benefit of priority, under 35 U.S.C. Section 119(e), to David George et al., U.S. patent application Ser. No. 61/935,117, entitled “ASSISTED PRODUCT IDENTIFICATION,” filed on Feb. 3, 2014 (Attorney Docket No. 5978.074PRV), each of which is hereby incorporated by reference herein in its entirety.

### TECHNICAL FIELD

This document pertains generally, but not by way of limitation, to a system and related method for identifying products.

### BACKGROUND

Consumers must often identify specific information about a purchased product for a variety of reasons. For example, certain upgrades or accessories can be available for specific products or specific models of a product, but unavailable or incompatible with others. Similarly, manufacturer information such as manuals, warranty information or recall information is typically directed to specific products or product information. Accordingly, consumers must accurately identify product information regarding a product such as model number, model year and other identifying information. While product identifying information is often printed on product packaging, the product information is often absent from the product itself making identification of the product difficult after removal of the packaging.

A consumer can identify a product in a variety of ways. A serial number identifying the specific unit and correspondingly more general model information is typically printed on the product. However, the serial number is often concealed on the underside, the backside or on an internal surface of the product to minimize disruption to the aesthetic appearance of the product. As a result, the serial number can be difficult to locate and retrieve, particularly on larger and more difficult to move appliances and similar products. In addition, serial numbers are typically long alphanumeric strings, which can be difficult to remember and transcribe correctly. Finally, the serial number still requires access to a manufacturer database to retrieve the additional model information, which may not be publically available.

Alternatively, the manufacturer name and model name are often featured prominently on the front or top of the product. However, the same model name may generically refer to a plurality of different versions of a product or a series of products that are regularly updated or changed each product cycle. Accordingly, the model and manufacturer names may not provide sufficient information to accurately identify the product. In addition, generic, house label or other similar products manufactured and sold by different entities under a different label can further complicate identification of the product.

The inability to accurately identify a product from the product unit can result in wasted money and effort by purchasing incorrect upgrades or accessories. Similarly, a misidentified product can have severe consequences if the incorrect manual is used or a recall notice is wrongly ignored.

### OVERVIEW

The present inventors have recognized, among other things, that a problem to be solved can include accurately identifying an object to determine relevant product identification information. In an example, the present subject matter can provide a solution to this problem, such as by comparing a visual representation of an unidentified object with a visual mask corresponding to a known product. The mask can include at least one distinctive feature that can be compared to the visual features of the visual representation. Identified correspondence between the mask and the visual presentation can then be used to identify the unidentified object. In at least one example, the visual representation of the unidentified object can be compared against a library of masks to identify the unidentified object. Each mask can correspond to a different known product.

In an example, the mask can be overlaid onto the visual representation to form a composite image for comparing the mask with the visual representation. The mask can be a partially transparent image, a wire-frame image, an outline image or other image type allowing visual comparison between the overlaid mask and the underlying visual representation in the composite image. In an example, the mask can include markers for aligning and sizing the visual representation with the mask. The markers can be aligned with certain visual features of the visual representation to provide visual cues for aligning or resizing the visual representation to correspond to the mask. In at least one example, the user can be prompted to change the visual representation or capture a new visual representation if the markers cannot be accurately aligned with the appropriate visual features of the visual representation.

The analysis of the composite image can be made by a user and/or through visual processing. In at least one example, the composite image can be visually processed to identify regions of the composite image that have different color intensities than the original visual representation. The different color intensities can correspond to areas where the distinctive features of the mask differ from the visual features of the visual representation. If the number of identified regions and/or the changes in intensities exceeds a predetermined threshold, a determination can be made as to whether the unidentified product unit in the visual representation differs from the identified product unit corresponding to the mask. The visual processing can be made on handheld consumer devices such as smartphones, tablets and other devices to permit product identification by consumers to be done conveniently and accurately. Such convenience and accuracy may reduce costs due to mistakes or lack of action on the consumer's part. Further, such convenience may reduce shopping barriers for consumers and thus increase sales of a variety of products and services.

A system for assisted product identification according to an example of the present subject matter can include a mask module for providing a mask of a known product. The system can also include a target module for providing a visual representation of an unidentified object. The system can also include a composition module for displaying the visual representation of the object in a bounded area of a display and overlaying the mask on the bounded area. The system can also include a selection module for receiving a correspondence metric in response to overlaying the mask on the bounded area. The correspondence metric can be indicative of correspondence of the mask and the visual representation of the unidentified object.

A method for assisting in product identification can comprise providing a mask of a product providing a visual representation of an unidentified object and displaying the visual representation of the unidentified object in a bounded area of a display of a user device. The method can also include overlaying the mask on the bounded area and receiving a correspondence metric in response to overlaying the mask on the bounded area. The correspondence metric being an indication of correspondence between the mask and the visual representation of the unidentified object.

This overview is intended to provide an overview of subject matter of the present patent application. It is not intended to provide an exclusive or exhaustive explanation of the present subject matter. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of an assisted product identification system according to an example of the present disclosure.

FIG. 2 is a representative example of a mask of a known product, according to an example of the present disclosure.

FIG. 3 is a schematic diagram of a process for assisted product identification, according to an example of the present disclosure.

FIGS. 4 to 10 are illustrative screen shots for an application implementing assisted product identification, according to an example of the present disclosure.

FIG. 11 is a schematic diagram illustrating a machine upon which assisted product identification can be implemented, according to an example of the present disclosure.

### DETAILED DESCRIPTION

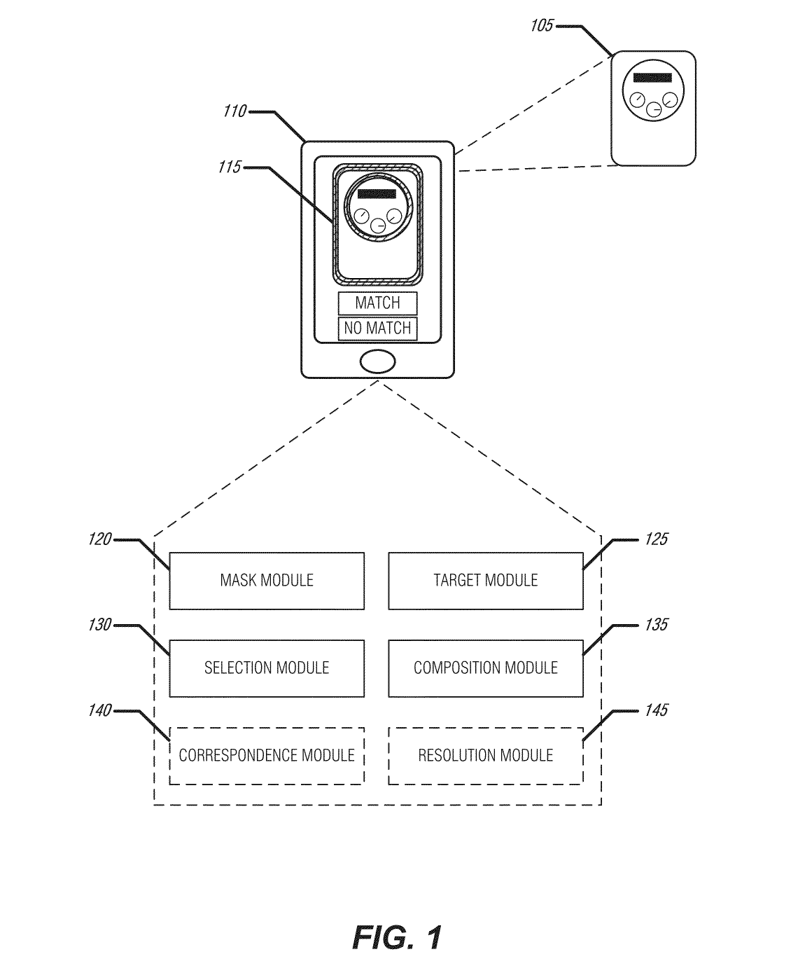

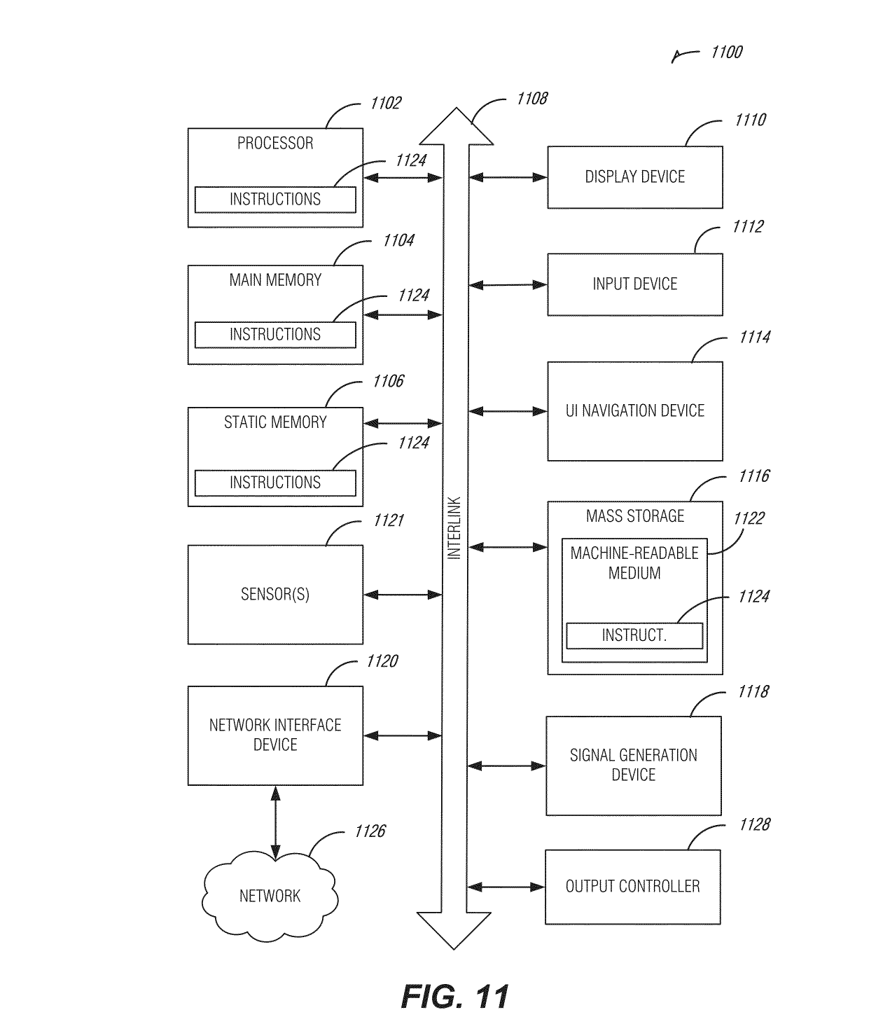

FIG. 1 is a block diagram of an example of a system for assisted product identification. The system can include a device 110 able to acquire (e.g., via an integrated camera or a communication mechanism) a visual representation of an object 105. The device 110 can include a mask module 120, a target module 125, a selection module 130, and a composition module 135. In an example, the device can optionally include any or all of a correspondence module 140 or a resolution module 145. Example information of other possible device features is described below with respect to FIG. 11.

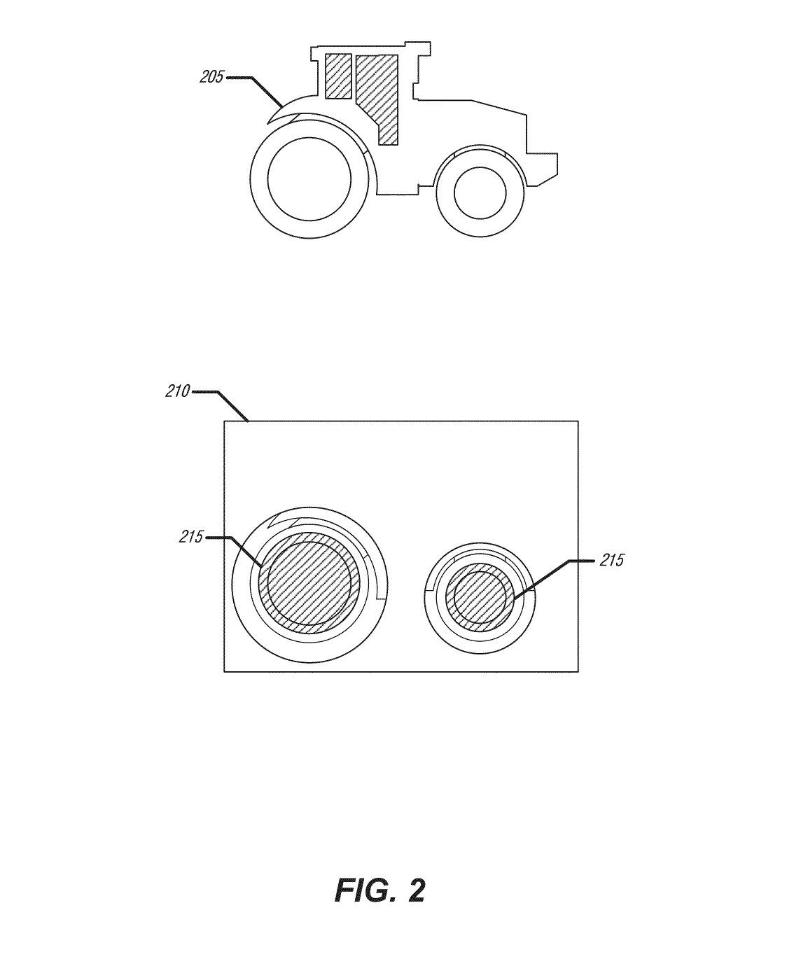

The mask module 120 can be arranged to provide a visual mask of a product. In an example, the mask can include an image with fully transparent portions and non-fully transparent portions. In a typical example, the non-fully transparent portions correspond to the distinctive feature of an object being sought while the fully transparent portions correspond to negative space (e.g., space between fan grill elements) of the object. However, these roles can be reversed. In an example, no portion of the image is fully transparent. In an example, the non-fully transparent portions are opaque (i.e., completely obscure image elements underneath these portions when the mask is overlaid onto another image). As illustrated below with respect to FIG. 2, combinations of different transparency levels in the mask can be used for different purposes. For example, a first portion can be used to identify areas of interest in the product. A second portion can be used to match a visual feature of the product. In an example, different colors can be used in the mask in order to identify different distinctive features of the product. For example, given three products A, B, and C, products A and B can share a first visual feature and products B and C can share a second visual feature. The mask for product B can include a first color portion corresponding to the first visual feature and a second color portion corresponding to the second visual feature.

The target module 125 can be arranged to provide a visual representation of the object 105 (e.g., prior to identification as a product). In an example, the visual representation of the object can include an image of the object. This image can be captured by the device 110 (e.g., via an integrated camera) or by a camera, after which the image can be imported to the device 110. In an example, the visual representation of the object can be video of the object (e.g., including the image). When the visual representation is video, the described mechanisms can operate in an augmented reality fashion, whereby the “view” through the lens is changed in real-time.

In an example, the target module 125 can be arranged to adjust color information of the image. In an example, adjusting the color information can include increasing contrast between colors of the image. Increasing contrast can, for example, facilitate feature recognition between different areas of the visual feature of the object 105. In an example, the colors can be reduced (e.g., to black and white) or changed (e.g., red can be mapped to white) to highlight the distinctive visual feature as captured by the camera.

In an example, the target module 125 can be arranged to maintain a plurality of product masks including the mask 115. Thus, a library of product masks can be used in the identification process. This can be useful when a vendor seeking the product identification has multiple products or product models. The library can be maintained locally or remotely (e.g., by a cloud service) to the device 110.

In an example, the target module 125 can be arranged to provide a scale indication of the object 105 in the visual representation of the object. For example, a captured image can be modified to include a bounding box, scale, or other markers. These can be used, for example, on a live (e.g., video prior to image capture) image of the camera as the user attempts to snap a picture of the object 105. When, for example, the edges of the object's face are proximate to the edges of the bounding box, the captured image at that point will work with the mask 115. In an example, a scale can be used and matched to an aspect of the object 105 to determine correct image capture. For example, the user can be instructed to measure and attach a two-inch piece of paper to the object 105. The scale element can then correspond to the piece of paper; the correct distance to capture the image being achieved when the scale element matches the piece of paper. In an example, image capture instructions can be displayed to the user. In an example, one or more of the above identified calibration mechanisms can be included in the mask 115 and used when the mask 115 is overlaid on the visual representation of the object 105.

The composition module 135 can be arranged to display the visual representation of the object in a bounded area of a display of the device. Thus, the visual representation inhabits an identifiable area of the user's screen. The composition module 135 can be arranged to overlay the mask 115 on the bounded area. Thus, the mask partially obscures the visual representation of the object 105. As the overlay is performed on the device 110, a variety of image processing techniques can be used to perform the overlay. For example, when the mask has portions that are not opaque, alpha compositing techniques can be used to combine the visual representation and the mask 115 in the final output.

In an example, the composition module 135 can be arranged to cycle through a plurality of product masks. As noted above, this can be useful when a vendor has more than one product or model. Further, a single product can have a plurality of corresponding masks. This can be useful when different facets of the object 105 can be used to identify the product. In an example, the cycling can include a transition from a first product mask to a second product mask in response to receiving user input. In an example, the user input can be a selection of the second product mask (e.g., from a listing or display) of the product masks. In an example, the selection can be a direction. For example, the user can select NEXT to move a linear selection cycle to the next product mask. Direction can include any relevant direction given the data model of the mask library. For example, FORWARD and BACK can be used to navigate different products while UP and DOWN can be used to navigate models within a product.

In an example, the cycling can be automatic. For example, the cycling can include a transition from a first product mask to a second product mask in response to an elapsed timer. In an example, the transition can be prompted by an automatic determination that the first product mask does not match the visual representation, such as that described below with respect to the correspondence module 140.

The selection module 130 can be arranged to receive a correspondence metric in response to overlaying the mask on the bounded area. The correspondence metric is an indication of correspondence between the mask and the visual representation of the object. In an example, the correspondence metric can be expressed as degree of correspondence between the mask and the visual representation of the object. In an example, the correspondence metric can be a binary value (i.e., the correspondence metric has only two possible values) and either indicates a correspondence or a lack of correspondence. In the binary value example, correspondence is equivalent to complete correspondence and lack of correspondence is equivalent to a complete lack of correspondence. It is not that these absolutes need be objectively true; however, for processing purposes, they are treated in this way.

In an example, the correspondence metric can be a percentage. Thus, the correspondence metric can embody a probability of a match. In an example, the correspondence metric can be a word-based enumeration of degrees, the enumeration including at least three elements. Enumeration is herein used to refer to a data structure of a closed list as used in computer science. An example, enumeration can include HIGH, MEDIUM, and LOW to indicate the degree of correspondence. In an example, the degree can be received from a user interface in response to a user selection of the degree. Thus, a user can make the decision of correspondence degree and enter that decision into the user interface. The decision can then be pushed or pulled to the selection module 130 to register the selection.

In an example, the selection module 130 can be arranged to signal the composition module 135 to stop cycling through the plurality of product masks in response to receiving the correspondence metric. Thus, for example, once a positive correspondence is determined, indicating that the mask matches the visual representation of the object 105, cycling (e.g., automatic cycling) can cease.

The correspondence module 140 can be arranged to measure the correspondence and provide the degree to the selection module 130. Thus, the correspondence can be determined automatically without user intervention. In an example, the correspondence can be determined using image processing techniques. For example, given a 50% transparent black portion of the mask and an anticipated bright white corresponding visual feature on the object 105, when the resultant composite image (e.g., after overlaying the mask on the visual representation of the object 105) is a grey (e.g., halfway between black and white), it can be determined that there is a match. In an example, partial matches can be expressed as percentages as noted above.

The resolution module 145 can be arranged to request additional information about the object 105 when, for example, the degree of correspondence is in between lack of correspondence or correspondence (i.e., there is some question as to whether the mask 115 corresponds to the visual representation of the object 105). Thus, when a question exists, additional information can be used to resolve whether or not the object 105 is a given product. In an example, the additional information can be any or all of a dimension, a color, a date of purchase, a locale of purchase, a smell, an identification of a construction material, an installation location or an application for which the object 105 is used. For example, two bathroom fan grills may have a similar design. However the first bathroom fan housing may be bigger than the second. Thus, an indeterminate, but not negative, correspondence can be measured between the mask 115 and the visual representation of the object 105, and an additional question of housing dimension can be posed to the user. The answer to this question can help identify one bathroom fan over another.

The mask based approaches discussed above assist users, in a convenient and accurate way, in identifying products. This identification can be leveraged to sell other products and services to consumers.

FIG. 2 illustrates an example of a mask of a product. In this example, the product 205 is a tractor. The product 205 is shown fully above and covered by a mask below. The mask includes two components, an opaque overlay 210 in the form of a rectangle with two cut-outs corresponding to the product's wheels and, within these cut-outs, semi-transparent overlays 215. In this example, the opaque overlay 210 helps the user position the mask onto the visual representation of the product. Further, the opaque overlay obscures details that may be irrelevant to the product identification for the user. The semi-transparent overlays 215 can be used by the user to determine if, for example, the hub placement, design, or other visual feature matches the overlay to permit product identification.

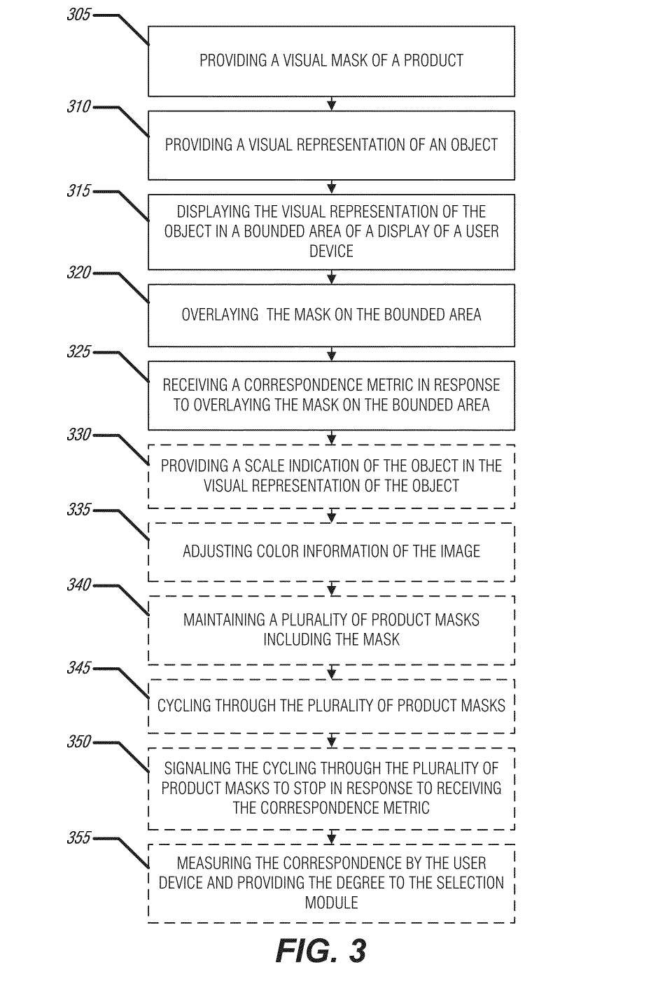

FIG. 3 illustrates a flow diagram of an example of a method for assisted product identification. The operations of the method can be performed on a machine, such as the device described above with respect to FIG. 1 or below with respect to FIG. 11.

At operation 305, a visual mask of a product can be provided. In an example, the mask can include an image with fully transparent portions and non-fully transparent portions. In an example, the non-fully transparent portions can be opaque.

At operation 310, a visual representation of an object can be provided. In an example, the visual representation of the object can include an image of the object. In an example, the visual representation of the object can be video of the object. At operation 315, the visual representation of the object can be displayed in a bounded area of a display of a user device.

At operation 320, the mask can be overlaid onto the bounded area of the display.

At operation 325, a correspondence metric can be received in response to overlaying the mask on the bounded area. As described herein, the correspondence metric is an indication of how closely the mask corresponds to the visual representation of the object. In an example, the correspondence metric can be a degree of correspondence between the mask and the visual representation of the object. In an example, the correspondence metric can be a binary value (e.g., yes or no) and either indicates a correspondence or a lack of correspondence. In an example, the correspondence metric can be a percentage (e.g., 50% correspondence). In an example, the correspondence metric can be a word-based enumeration of degrees, the enumeration including at least three elements. For example, the enumeration can include HIGH, MEDIUM HIGH, MEDIUM, MEDIUM LOW, and LOW. In an example, the degree can be received from a user interface in response to a user selection of the degree. In an example, a request, by the user device, for additional information about the object can be performed when the degree is between lack of correspondence or correspondence. That is, if the correspondence metric is not absolutely affirmative or negative, additional information can be sought. In an example, the additional information can be any one or more of a dimension, a color, a date of purchase, a locale of purchase, a smell, an identification of a construction material, an installation location, or an application for which the object is used.

At operation 330, a scale indication of the object can be provided in the visual representation of the object.

At operation 335, color information of the image can be adjusted. In an example, to adjust the color information can include increasing contrast between colors of the image.

At operation 340, a plurality of product masks can be maintained. At operation 345, a cycling through the plurality of product masks can be performed. In an example, the cycling can include a transition from a first product mask to a second product mask in response to receiving user input. In an example, the user input can be any one or more of a selection of the second product mask or a selection of a direction. In an example, the direction can be forward or backward. In an example, the cycling can include a transition from a first product mask to a second product mask in response to an elapsed timer. Thus, instead of using user input to select the second product mask, the product masks can automatically cycle and the user can simply indicate when a match comes up.

At operation 350, the cycling through the plurality of products masks can be signaled to stop in response to receipt of the correspondence metric.

At operation 355, the correspondence can be measured by the used device and provided to the selection operation component. Thus, for example, image processing can be used to ascertain the degree to which the mask corresponds to the visual representation without user input.

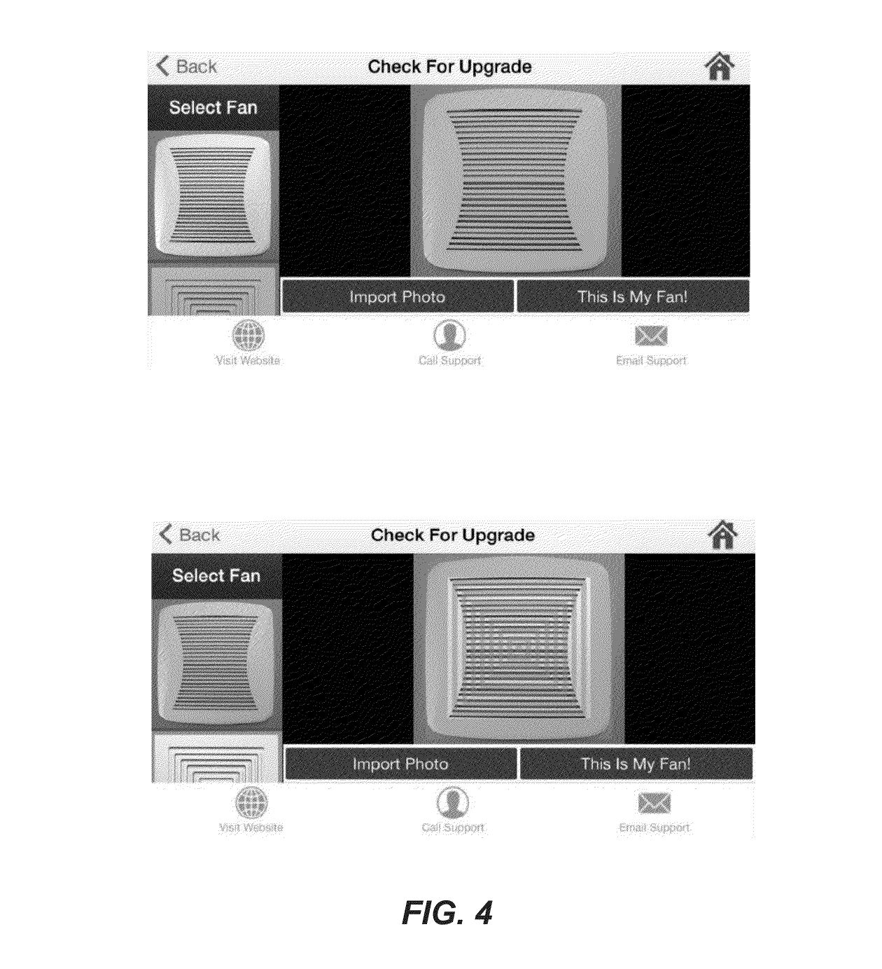

FIGS. 4-10 illustrate screenshots from an example application for assisted product identification, according to an embodiment.

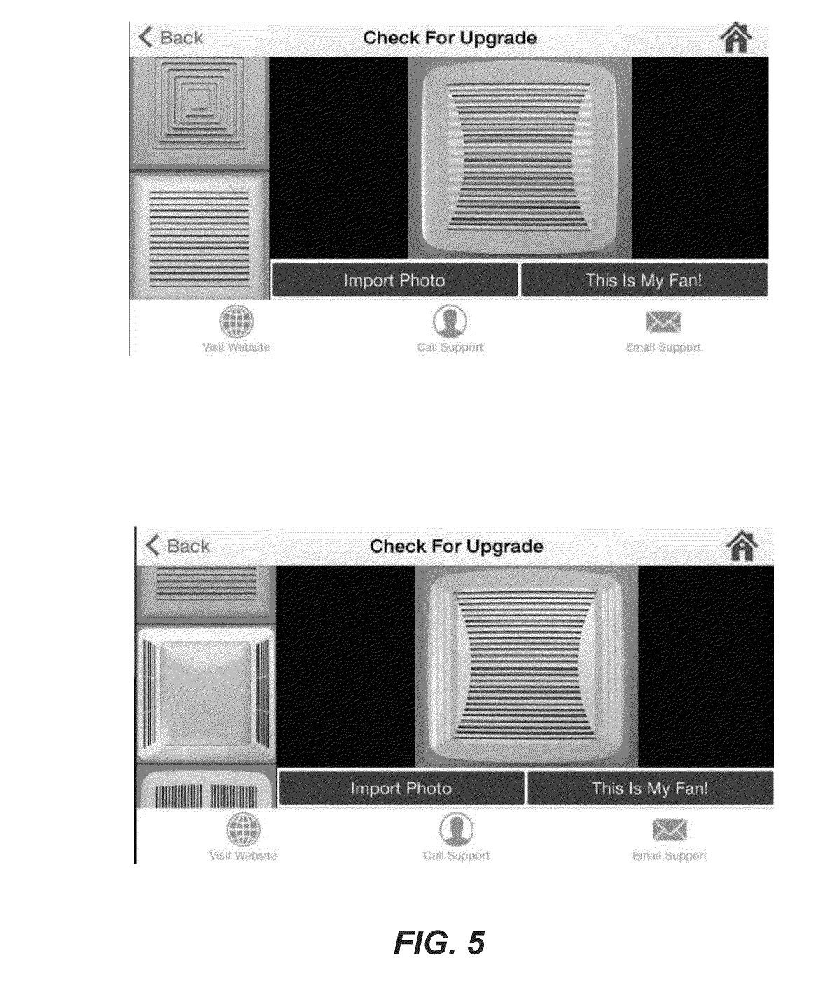

FIG. 4 includes two images. The top image illustrates a mask overlaid a blank visual representation (e.g., prior to an actual visual representation of the product) visual representation of a product in the center and a mask selection on the left. At the bottom center is an option to import the visual representation and also an option to identify a positive correspondence of a displayed mask to the product. The bottom image illustrates a non-blank visual representation of a bathroom fan product and a mask overlaid on top of the visual representation. FIG. 5 illustrates two additional masks overlaid on the visual representation.

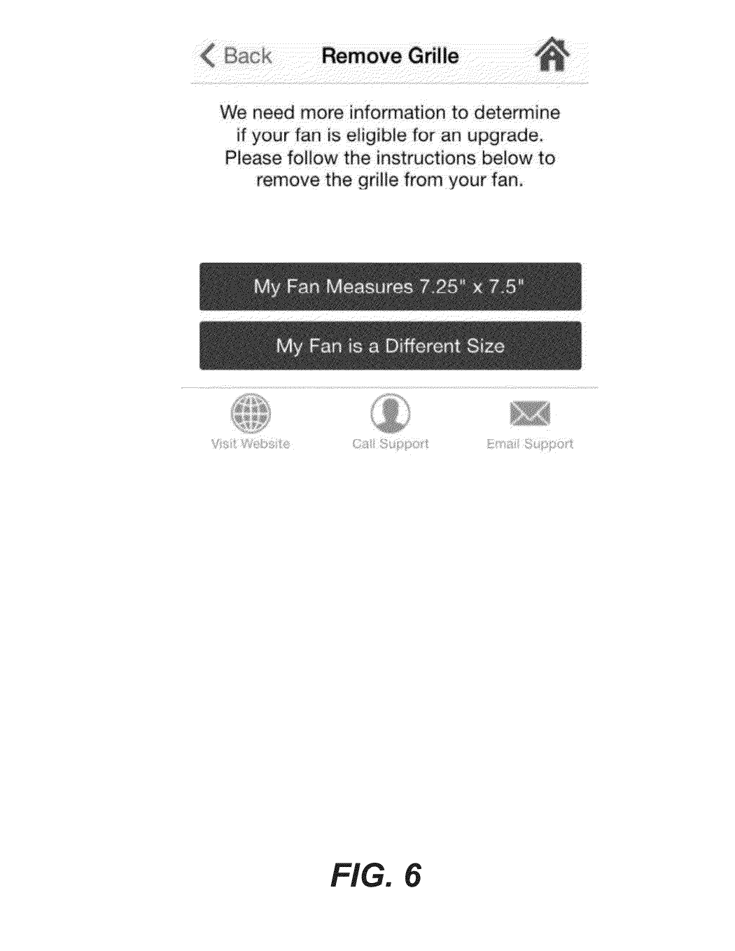

FIG. 6 illustrates a user interfaces to request additional information from the user. In this example, the user is asked to confirm whether the bathroom fan is of a particular measurement.

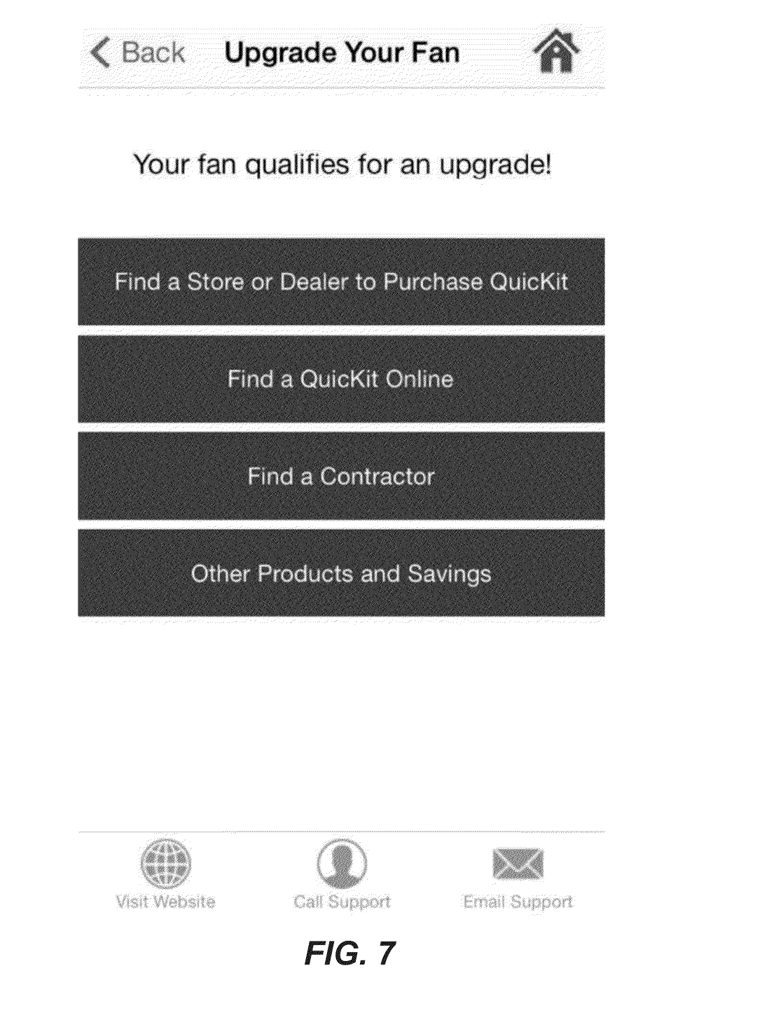

FIG. 7 illustrates an example menu interface to connect the user with different resources when an upgrade is available based on the product identification.

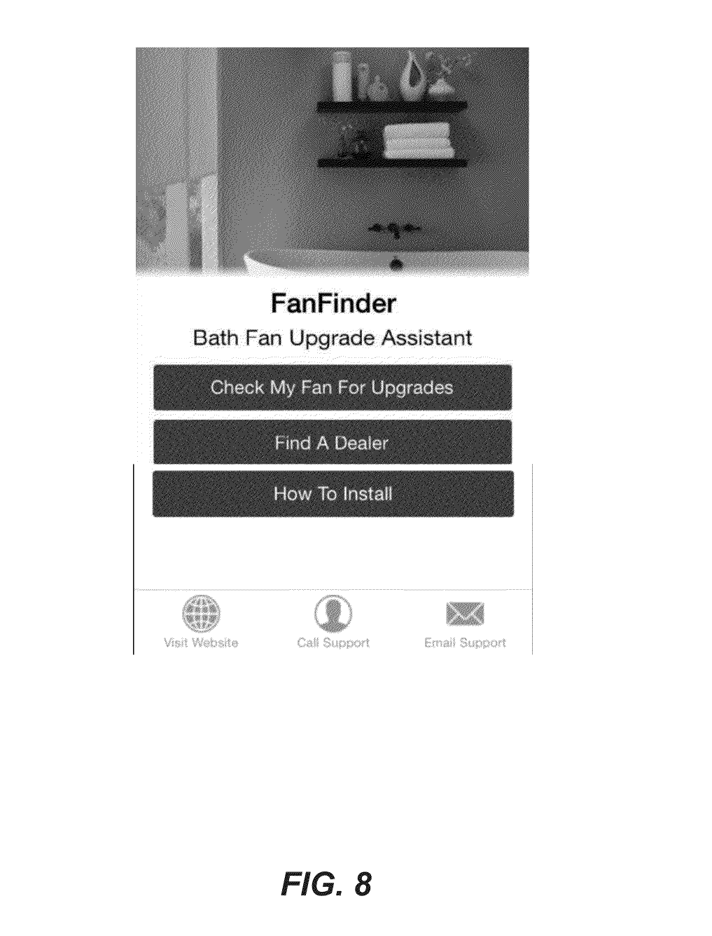

FIG. 8 illustrates an example menu interface to manage product identification for the purposes of determining whether an upgrade is available.

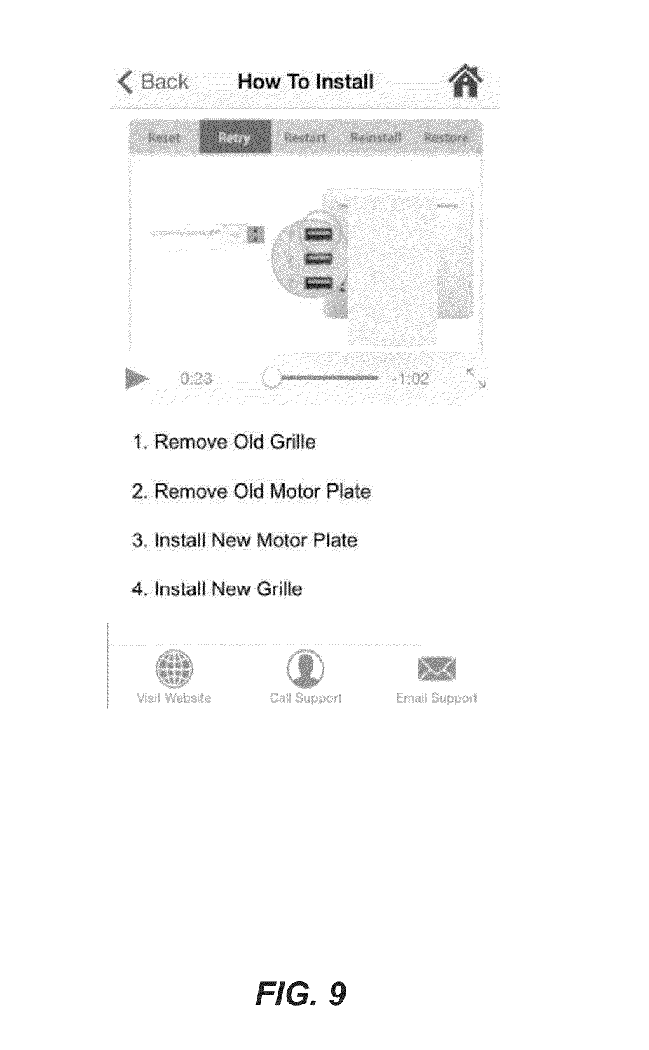

FIG. 9 illustrates an example tutorial interface to instruct the user on steps to install a bathroom fan upgrade. The tutorial can include video, audio, or other media elements to facilitate the process.

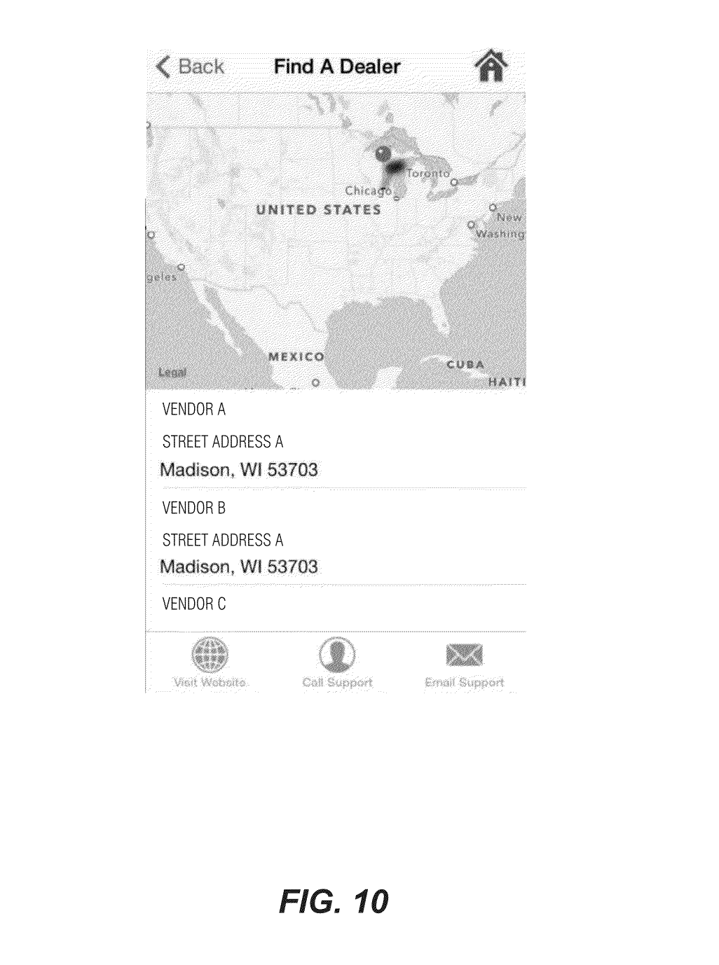

FIG. 10 illustrates an example of a dealer locator interface. This interface can be used to facilitate user connection to resources to, for example, complete the fan upgrade.

FIG. Error! Reference source not found. illustrates a block diagram of an example machine Error! Reference source not found.00 upon which any one or more of the techniques (e.g., methodologies) discussed herein may perform. In alternative embodiments, the machine Error! Reference source not found.00 may operate as a standalone device or may be connected (e.g., networked) to other machines. In a networked deployment, the machine Error! Reference source not found.00 may operate in the capacity of a server machine, a client machine, or both in server-client network environments. In an example, the machine Error! Reference source not found.00 may act as a peer machine in peer-to-peer (P2P) (or other distributed) network environment. The machine Error! Reference source not found.00 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) Error! Reference source not found.00 may include a hardware processor Error! Reference source not found.02 (e.g., a central processing unit (CPU), a graphics processing unit (GPU), a hardware processor core, or any combination thereof), a main memory Error! Reference source not found.04 and a static memory Error! Reference source not found.06, some or all of which may communicate with each other via an interlink (e.g., bus) Error! Reference source not found.08. The machine Error! Reference source not found.00 may further include a display unit Error! Reference source not found.10, an alphanumeric input device Error! Reference source not found.12 (e.g., a keyboard), and a user interface (UI) navigation device Error! Reference source not found.14 (e.g., a mouse). In an example, the display unit Error! Reference source not found.10, input device Error! Reference source not found.12 and UI navigation device Error! Reference source not found.14 may be a touch screen display. The machine Error! Reference source not found.00 may additionally include a storage device (e.g., drive unit) Error! Reference source not found.16, a signal generation device Error! Reference source not found.18 (e.g., a speaker), a network interface device Error! Reference source not found.20, and one or more sensors Error! Reference source not found.21, such as a global positioning system (GPS) sensor, compass, accelerometer, or other sensor. The machine Error! Reference source not found.00 may include an output controller Error! Reference source not found.28, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device Error! Reference source not found.16 may include a machine readable medium Error! Reference source not found.22 on which is stored one or more sets of data structures or instructions Error! Reference source not found.24 (e.g., software) embodying or utilized by any one or more of the techniques or functions described herein. The instructions Error! Reference source not found.24 may also reside, completely or at least partially, within the main memory Error! Reference source not found.04, within static memory Error! Reference source not found.06, or within the hardware processor Error! Reference source not found.02 during execution thereof by the machine Error! Reference source not found.00. In an example, one or any combination of the hardware processor Error! Reference source not found.02, the main memory Error! Reference source not found.04, the static memory Error! Reference source not found.06, or the storage device Error! Reference source not found.16 may constitute machine readable media.

While the machine readable medium Error! Reference source not found.22 is illustrated as a single medium, the term “machine readable medium” may include a single medium or multiple media (e.g., a centralized or distributed database, and/or associated caches and servers) configured to store the one or more instructions Error! Reference source not found.24.

The term “machine readable medium” may include any medium that is capable of storing, encoding, or carrying instructions for execution by the machine Error! Reference source not found.00 and that cause the machine Error! Reference source not found.00 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions Error! Reference source not found.24 may further be transmitted or received over a communications network Error! Reference source not found.26 using a transmission medium via the network interface device Error! Reference source not found.20 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device Error! Reference source not found.20 may include one or more physical jacks (e.g., Ethernet, coaxial, or phone jacks) or one or more antennas to connect to the communications network Error! Reference source not found.26. In an example, the network interface device Error! Reference source not found.20 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine Error! Reference source not found.00, and includes digital or analog communications signals or other intangible medium to facilitate communication of such software.

### VARIOUS NOTES & EXAMPLES

Example 1 can include a device comprising a mask module to provide a visual mask of a product; a target module to provide a visual representation of an object; a composition module to: display the visual representation of the object in a bounded area of a display of the device; and overlay the mask on the bounded area; and a selection module to receive a correspondence metric in response to overlaying the mask on the bounded area, the correspondence metric being an indication of correspondence between the mask and the visual representation of the object.

In Example 2, the device of Example 1, wherein the visual representation of the object comprises an image of the object.

In Example 3, the device of Example 2, wherein the visual representation of the object is video of the object.

In Example 4, the device of any one or more of Examples 2-3, wherein the target module is to provide a scale indication of the object in the visual representation of the object.

In Example 5, the device of any one or more of Examples 2-4, wherein the target module is to adjust color information of the image.

In Example 6, the device of Example 5, wherein to adjust the color information, the target module is to increase contrast between colors of the image.

In Example 7, the device of any one or more of Examples 1-6, wherein the mask comprises an image with fully transparent portions and non-fully transparent portions.

In Example 8, the device of Example 7, wherein the non-fully transparent portions are opaque.

In Example 9, the device of any one or more of Examples 1-8, wherein the target module is to maintain a plurality of product masks including the mask.

In Example 10, the device of Example 9, wherein the composition module is to cycle through the plurality of product masks.

In Example 11, the device of Example 10, wherein the selection module is to signal the composition module to stop cycling through the plurality of product masks in response to receiving the correspondence metric.

In Example 12, the device of any one or more of Examples 10-11, wherein the cycling includes a transition from a first product mask to a second product mask in response to receiving user input.

In Example 13, the device of Example 12, wherein the user input is at least one of a selection of the second product mask or a selection of a direction, the direction being at least one of forward or backward.

In Example 14, the device of any one or more of Examples 10-13, wherein the cycling includes a transition from a first product mask to a second product mask in response to an elapsed timer.

In Example 15, the device of any one or more of Examples 1-14, wherein the correspondence metric is a degree of correspondence between the mask and the visual representation of the object.

In Example 16, the device of Example 15, wherein the correspondence metric is a binary value and either indicates a correspondence or a lack of correspondence.

In Example 17, the device of any one or more of Examples 15-16, wherein the correspondence metric is at least one of a percentage or word-based enumeration of degrees, the enumeration including at least three elements.

In Example 18, the device of any one or more of Examples 15-17, comprising a correspondence module to measure the correspondence and provide the degree to the selection module.

In Example 19, the device of any one or more of Examples 15-18, wherein the degree is received from a user interface in response to a user selection of the degree.

In Example 20, the device of any one or more of Examples 15-19, comprising a resolution module to request additional information about the object when the degree is in between lack of correspondence or correspondence.

In Example 21, the device of Example 20, wherein the additional information is at least one of a dimension, a color, a date of purchase, a locale of purchase, a smell, an identification of a construction material, an installation location, or an application for which the object is used.

In Example 22, the subject matter of any one or more of Examples 1-21 can optionally include a method comprising: providing a visual mask of a product; providing a visual representation of an object; displaying the visual representation of the object in a bounded area of a display of a user device; overlaying the mask on the bounded area; and receiving a correspondence metric in response to overlaying the mask on the bounded area, the correspondence metric being an indication of correspondence between the mask and the visual representation of the object.

In Example 23, the method of Example 22, wherein the visual representation of the object comprises an image of the object.

In Example 24, the method of Example 23, wherein the visual representation of the object is video of the object.

In Example 25, the method of any one or more of Examples 23-24, comprising providing a scale indication of the object in the visual representation of the object.

In Example 26, the method of any one or more of Examples 23-25, comprising adjusting color information of the image.

In Example 27, the method of Example 26, wherein to adjust the color information includes increasing contrast between colors of the image.

In Example 28, the method of any one or more of Examples 22-27, wherein the mask comprises an image with fully transparent portions and non-fully transparent portions.

In Example 29, the method of Example 28, wherein the non-fully transparent portions are opaque.

In Example 30, the method of any one or more of Examples 22-29 comprising maintaining a plurality of product masks including the mask.

In Example 31, the method of Example 30, comprising cycling through the plurality of product masks.

In Example 32, the method of Example 31, comprising signaling the cycling through the plurality of product masks to stop in response to receiving the correspondence metric.

In Example 33, the method of any one or more of Examples 31-32, wherein the cycling includes a transition from a first product mask to a second product mask in response to receiving user input.

In Example 34, the method of Example 33, wherein the user input is at least one of a selection of the second product mask or a selection of a direction, the direction being at least one of forward or backward.

In Example 35, the method of any one or more of Examples 31-34, wherein the cycling includes a transition from a first product mask to a second product mask in response to an elapsed timer.

In Example 36, the method of any one or more of Examples 22-35, wherein the correspondence metric is a degree of correspondence between the mask and the visual representation of the object.

In Example 37, the method of Example 36, wherein the correspondence metric is a binary value and either indicates a correspondence or a lack of correspondence.

In Example 38, the method of any one or more of Examples 36-37, wherein the correspondence metric is at least one of a percentage or word-based enumeration of degrees, the enumeration including at least three elements.

In Example 39, the method of any one or more of Examples 36-38, comprising measuring the correspondence by the user device and providing the degree to the selection operation.

In Example 40, the method of any one or more of Examples 36-39, wherein the degree is received from a user interface in response to a user selection of the degree.

In Example 41, the method of any one or more of Examples 36-40, comprising requesting, by the user device, additional information about the object when the degree is between lack of correspondence or correspondence.

In Example 42, the method of Example 41, wherein the additional information is at least one of a dimension, a color, a date of purchase, a locale of purchase, a smell, an identification of a construction material, an installation location, or an application for which the object is used.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

What is claimed is:

1. A system for assisted product identification, comprising:
a mask module for providing a mask of a known product;
a target module for providing a visual representation of an unidentified object;
a composition module for:
displaying the visual representation of the object in a bounded area of
a display; and
overlaying the mask on the bounded area; and
a selection module for receiving a correspondence metric in response to overlaying the mask on the bounded area;
wherein the correspondence metric is indicative of correspondence of the mask and the visual representation of the unidentified object.

2. The system of claim 1, wherein the visual representation of the object comprises at least one of an image of the unidentified object and a video of the unidentified object.

3. The system of claim 1, wherein the target module provides a scale indication of the unidentified object in the visual representation of the unidentified object.

4. The system of claim 3, wherein the target module adjusts color information of the image.

5. The system of claim 4, wherein the target module increases contrast between colors of the image to adjust the color information.

6. The system of claim 1, wherein the mask comprises an image with at least one fully transparent portion and at least one semi-transparent portion.

7. The system of claim 6, wherein the at least one semi-transparent portion is opaque.

8. The system of claim 1, wherein the target module maintains a plurality of masks including at least a first mask and a second mask, wherein each mask of the plurality of masks corresponds to a known product.

9. The system of claim 8, wherein the composition module transitions from the first mask to the second mask in response to at least one of a user input and an elapsed timer.

10. The system of claim 9, wherein the selection module signals the composition module to stop cycling through the plurality of product masks in response to receiving the correspondence metric.

11. The system of claim 9, wherein the user input is at least one of a selection of the second product mask or a selection of a direction, the direction being at least one of forward or backward.

12. The system of claim 1, wherein the correspondence metric is a degree of correspondence between the mask and the visual representation of the object.

13. The system claim 12, wherein correspondence metric is a binary value and either indicates a correspondence or a lack of correspondence.

14. The system of claim 13, further comprising a correspondence module to measure the correspondence and provide the degree to the selection module.

15. The system of claim 12, wherein the correspondence metric is at least one of a percentage or word-based enumeration of degrees, the enumeration including at least three elements.

16. The system of claim 15, wherein the degree is received from a user interface in response to a user selection of the degree.

17. The system of claim 16, further comprising a resolution module to request additional information about the object when the degree is in between lack of correspondence or correspondence.

18. The system of claim 17, wherein the additional information is at least one of a dimension, a color, a date of purchase, a locale of purchase, a smell, an identification of a construction material, an installation location, or an application for which the object is used.

19. A method for assisted product identification, comprising:
providing a mask of a product;
providing a visual representation of an unidentified object;
displaying the visual representation of the unidentified object in a bounded area of a display of a user device;
overlaying the mask on the bounded area; and
receiving a correspondence metric in response to overlaying the mask on the bounded area, the correspondence metric being an indication of correspondence between the mask and the visual representation of the unidentified object.

20. The method of claim 19, wherein the visual representation of the object comprises at least one of an image of the unidentified object and a video of the unidentified object.

21. The method of claim 19, further comprising providing a scale indication of the unidentified object in the visual representation of the unidentified object.

22. The method of claim 19, further comprising adjusting color information of the image.

23. The method of claim 22, wherein adjusting the color information includes increasing contrast between colors of the image.

24. The method of claim 19, wherein the mask comprises an image with at least one fully transparent portion and at least one semi-transparent portion.

25. The method of claim 24, wherein the non-fully transparent portions are opaque.

26. The method of claim 19, further comprising maintaining a plurality of masks including at least a first mask and a second mask, wherein each mask of the plurality of masks corresponds to a known product.

27. The method of claim 26, further comprising transitioning from the first mask to the second mask in response to at least one of a user input and an elapsed timer.

28. The method of claim 27, further comprising signaling the cycling through the plurality of masks to stop in response to receiving the correspondence metric.

29. The method of claim 26, wherein the user input is at least one of a selection of the second product mask or a selection of a direction, the direction being at least one of forward or backward.

30. The method of claim 19, wherein the correspondence metric is a degree of correspondence between the mask and the visual representation of the unidentified object.

31. The method of claim 30, wherein the correspondence metric is a binary value and either indicates a correspondence or a lack of correspondence.

32. The method of claim 31, wherein the correspondence metric is at least one of a percentage or word-based enumeration of degrees, the enumeration including at least three elements.

33. The method of claim 30, further comprising measuring the correspondence by the user device and providing the degree to the selection operation.

34. The method of claim 33, wherein the degree is received from a user interface in response to a user selection of the degree.

35. The method of claim 34, further comprising requesting, by the user device, additional information about the object when the degree is between lack of correspondence or correspondence.

36. The method of claim 35, wherein the additional information is at least one of a dimension, a color, a date of purchase, a locale of purchase, a smell, an identification of a construction material, an installation location, or an application for which the object is used.
